(19) United States
(12) Patent Application Publication
(10) Pub. No.: US 2008/0151058 A1
(43) Pub. Date: Jun. 26, 2008

(54) Method for Acquiring Video Data by Using Camera Mobile Phone as Computer Camera

(75) Inventors: Lian Xu, Beijing City (CN); Xiangdong Liu, Beijing City (CN); Chao Xu, Beijing City (CN); Wu Zheng, Beijing City (CN)

Correspondence Address: HUNTON & WILLIAMS LLP;INTELLECTUAL PROPERTY DEPARTMENT, RIVERFRONT PLAZA, EAST TOWER, 951 EAST BYRD ST., RICHMOND, VA, 23219-4074, US

(73) Assignee: LENOVO (BEIJING) LIMITED, Beijing (CN)

(21) Appl. No.: 11/722,947

(22) PCT Filed: Jul. 19, 2005
(86) PCT No.: PCT/CN2005/001074

§ 371 Date: Jun. 27, 2007

(30) Foreign Application Priority Data
Dec. 31, 2004 (CN) 200410103116.4

(51) Int. Cl. H04N 5/225

(52) U.S. Cl. 348/207.1; 348/E05.024

(57) ABSTRACT

The present invention provides a method for acquiring video data by using a camera mobile phone as a computer camera, which comprises: step A: the camera mobile phone is virtualized as a video-capturing device in a computer; step B: the mobile phone virtualized as the video-capturing device in step A is selected as current video-capturing device of the computer; step C: the computer sends a command for acquiring video data to the mobile phone selected as the current video-capturing device, and said mobile phone acquires video data according to the received command and transmits to the computer via wireless connection; and step D: the computer receives the video data transmitted from the mobile phone. The invention can achieve a resource sharing between the mobile phone and the computer, make full use of their functions, save the interface resource of the computer and enable the mobile phone to break down the capacity limitation during the acquisition of video data.

### BACKGROUND OF THE INVENTION

1. Field of Invention

The present invention relates to the field of computer application technology, and in particular to a method for acquiring video data by using a camera mobile phone as a computer camera.

2. Description of Prior Art

At present, computer cameras have been widely employed in various fields of actual application. For example, real-time capture of image can be implemented via a computer camera so as to perform video chatting or web conferencing with a computer, and a real-time monitoring of the environment can also be carried out on a computer via an attached computer camera.

In the prior art, a computer camera as a separate video-capturing device is required to be inserted into a USB interface of a computer such that the computer is enabled to obtain video images from the computer camera. Accordingly, the computer camera itself has to occupy a USB interface individually, which further strains the severely limited interface resource. In addition, since the connection between the computer and the computer camera has to be made via a USB line, the USB line should be carried along with the computer camera whenever the computer camera is in practical usage, so stricter requirement to the video-capturing device and certain limitation is thus imposed on the above connection. Furthermore, the computer camera has to be bought as an independent hardware device by a user, and this actually increases the user's expense and inflicts an adverse effect on the rapid popularization of various computer application using computer camera devices.

Meanwhile, a mobile phone as one of communication means has more diversified functions along with the continuous development of communication technology. Nowadays, a growing number of mobile phones have the capability of photographing, and some of them are provided with more pixels and higher resolution which even surpass those of a common computer camera. On the other hand, the length and photographing quantity of video files taken by a user subject to limitation due to a limited capacity of a memory card in a mobile phone, the mobile phone thus suffers from some restriction on capacity when employed as a video-capturing device.

### SUMMARY OF THE INVENTION

In view of the above problems, the primary object of the present invention is to provide a method for acquiring video data by using a camera mobile phone as a computer camera, which can utilize a mobile phone as a video-capturing device to acquire video data and transmit the acquired video data to a computer via a wireless communication so as to save the interface resource of the computer, lower the requirement on the video-capturing device and the restriction on connection between the computer and the video-capturing device and reduce a user's actual expense. Besides, the invention enables a camera mobile phone to achieve a breakthrough on capacity limitation and facilitates the acquisition of video data.

In order to achieve the above object, the present invention provides a method for acquiring video data by using a camera mobile phone as a computer camera, comprising:

### Step A: virtualizing the camera mobile phone as a video-capturing device in a computer;

### Step B: selecting the mobile phone virtualized as the video-capturing device in said step A as current video-capturing device of the computer;

Step C: sending a command for acquiring video data to the mobile phone selected as the current video-capturing device by the computer, and acquiring the video data according to the received command by said mobile phone and transmitting to the computer via a wireless connection; and

### Step D: receiving the video data transmitted from the mobile phone by the computer.

In the method, step A further comprises:

providing a virtual computer camera driver, which includes at least a function for registering a computer camera device, a function for setting and reading the properties of the computer camera device, a function for adding/uninstalling the computer camera device and a function for acquiring video data from the mobile phone; and

### Step A2: executing the virtual driver in said step A1, registering the camera mobile phone to the operating system of the computer, and setting the properties supported by the mobile phone.

In step A2, said virtual driver is a video micro-port driver for providing a callback routine to a video-class driver; and the video-class driver encapsulates general features of different types of streaming devices to support the control and manipulation of the video-capturing device by an application.
Said setting the properties supported by the mobile phone in step A2 includes invoking the function for setting the properties of the computer camera device and setting image resolution, image format, image compression format, video coding format and/or video-data-capturing frequency support by said mobile phone.

In the method, step B further comprises:

Invoking Said function for adding the computer camera device to add the mobile phone corresponding to the virtual driver to the computer, and then the mobile phone being selected as the current video-capturing device of the computer through an application.

In the method, step C further comprises:

Step C1: sending the command for acquiring video data to the virtual driver via the operating system by an application in the computer, and invoking said function for reading the properties of the computer camera device to read from the properties supported by the mobile phone particular properties as the device attributions for acquiring the current video data;
Step C2: converting the command, by the virtual driver, for acquiring video data into a corresponding control command for the mobile phone according to the read device attributions for acquiring the current video data and sending the converted command to the mobile phone via a wireless communication between the computer and the mobile phone, wherein the device attributions for acquiring the current video data is represented in said control command;

### Step C3: performing the acquisition of video data according to said received control command by the mobile phone; and

Step C4: using the wireless communication between the computer and the mobile phone, by the virtual driver, to acquire video data from the mobile phone by invoking said function for acquiring video data from the mobile phone and to transmit the acquired video data to the application in the computer.

Further, the method comprises a step of allocating in advance each independent memory block to corresponding video-capturing device, respectively, and said transmitting the video data to the application by the virtual driver in step C4 comprises:

### The virtual driver transmitting video data stored in said independent memory block up to the application through a device-reading routine owned by the virtual driver itself.

Before the virtual driver transmits the video data up to the application, the method further comprises transforming the format of the video data in the aspects including format and/or size.

### Before said transmitting the video data to the computer in step C, the method further comprises compressing the video data to be transmitted and then transmitting the compressed video data to the computer.

In the method, step D further includes restoring the received compressed video data to original video data by the computer.

In the method, step D further includes using said received video data as data source and playing or storing the video data by the application in the computer.

Said application is an application for video chatting or web conferencing.

The method further comprises invoking said function for uninstalling the computer camera device to uninstall the mobile phone corresponding to the virtual driver from the computer.

As can be seen from the above, the invention has the following benefits:

(1) according to the invention, a video data acquired by a mobile phone can be transmitted to a computer via a wireless communication between them, thereby saving the interface resource of the computer;
(2) according to the invention, employing a mobile phone as a computer camera device can eliminate the expense on a dedicated computer camera device; and with no need for a USB line to connect the mobile and the computer, the mobile pone is more convenient to use than a dedicated computer camera and the transmission of video data can be realized via a wireless communication, thereby attaining more flexible connection;
(3) according to the invention, since video data acquired by a mobile phone can be stored in a computer, the capacity insufficiency of the memory card in the mobile phone can be compensated for at the time of photographing or video recording, thereby breaking down the capacity restriction inflicted upon the video-related application of the mobile phone.

### BRIEF DESCRIPTION OF THE DRAWINGS

FIG. 1 is a flowchart for implementing the present invention.

FIG. 2 is a module block diagram of an embodiment of the present invention.

FIG. 3 is a flowchart of an embodiment of the present invention.

### DETAILED DESCRIPTION OF PREFERRED EMBODIMENTS

The present invention provides a method for acquiring video data by using a camera mobile phone as a computer camera, which comprises virtualizing a camera mobile phone as a computer camera device to register it to a computer, setting properties associated with the acquisition of video data for the mobile phone, selecting the registered mobile phone as the computer camera device, utilizing the virtualized result and the set associated properties to control and operate the mobile phone for acquiring video data, transmitting the acquired video data to the computer via a wireless communication and storing or displaying the received video data after the processing on the data by the computer. With the foregoing steps, this method can fulfill relevant operation by virtualizing the mobile phone as a camera device.

Hereafter, the present invention will be explained in detail with reference to the figures.

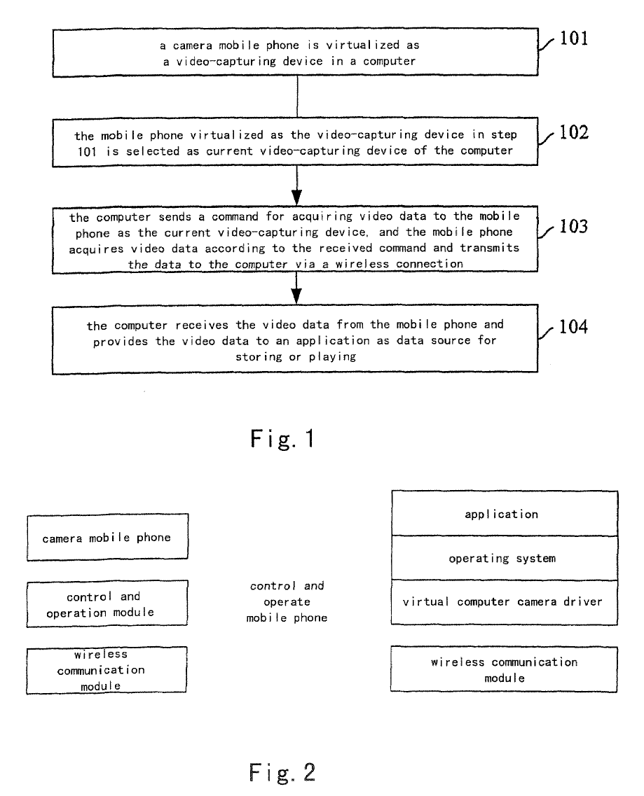

Referring to FIG. 1, the steps to implement the present invention are given as follows:

### Step 101: a camera mobile phone is virtualized as a video-capturing device in a computer;

### Step 102: the mobile phone virtualized as the video-capturing device in step 101 is selected as current video-capturing device of the computer;

Step 103: the computer sends a command for acquiring video data to the mobile phone selected as the current video-capturing device, and the mobile phone acquires video data according to the received command and transmits the data to the computer via a wireless connection;

### Step 104: the computer receives the video data from the mobile phone and provides the video data to an application as data source for storing or playing.

Specific implementation of the above steps is now described by way of embodiments and with reference to the figures. FIG. 2 shows a module block diagram for the specific application of a camera mobile phone according to one embodiment of the present invention, in which there usually include an application, operating system and a virtual computer camera driver on the side of a computer. In this embodiment, the virtual computer camera driver is configured to provide various properties and operations associated with the computer camera device to the operating system. Accordingly, during the initialization, the virtual computer camera driver registers the computer camera device to the operating system and completes the property setting for the computer camera device such that the camera mobile phone is virtualized as the computer camera device.

In the actual execution process, the application selects the mobile phone virtualized as the computer camera device as the current computer camera device with the help of the operating system, and then respective operating functions provided by the virtual computer camera driver are utilized to send a corresponding control command to the side of the mobile phone via a wireless communication module so as to control the mobile phone to acquire video data. The operating functions provided by the virtual computer camera driver are also utilized to receive video data from the side of the mobile phone via the wireless communication module, and the video data is transmitted to the application for practical use after certain processing such as compression and format conversion.

The camera phone device, which is the other side, usually includes a wireless communication module via which the bi-directional communication with the computer is conducted to receive the control command sent from the computer and to send the video data acquired by the mobile phone to the computer, a control and operation module configured to, based on the received control command, control the camera mobile phone to acquire video data, and the camera phone device itself configured to practice the acquisition of video data.

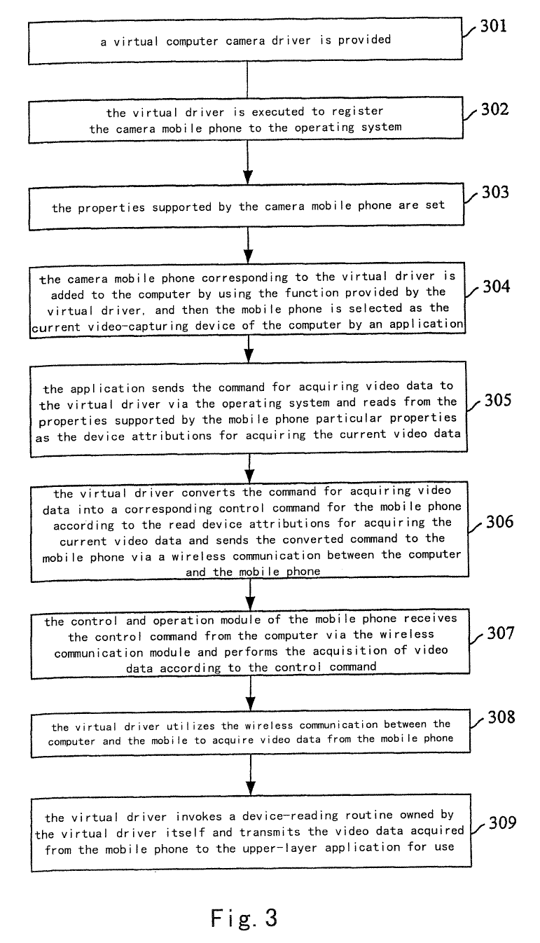

The following explanation is made to the detailed flow for implementing the present invention by example of the module structure illustrated in FIG. 2 and in connection with a specific embodiment. Referring to FIG. 3, the specific embodiment includes the following steps.

Step 301: a virtual computer camera driver is provided, which includes at least a function for registering a computer camera device, a function for setting and reading the properties of the computer camera device, a function for adding/uninstalling the computer camera device and a function for acquiring video data from the mobile phone.

In Windows operating system, various video-capturing devices are streaming devices, and the operating system provides a generic video-class driver for these streaming devices and stores the driver in a file Stream.sys such that general features of these streaming device can be encapsulated in the driver and provided to an application for control and manipulation of the video-capturing devices. In addition, each type of the video-capturing devices is provided with a video micro-port driver for providing a callback routine for said class driver to fulfill characterizing operations of the video-capturing device of each type. Therefore, in this embodiment of the invention, it only requires to design a micro-port driver for the camera mobile phone, and to include each of the above functions in the driver, and hence the setting of the virtual driver application is implemented. The micro-port driver includes the following functions in this embodiment:

### (1) Driver Entry Function for registering the video micro-port driver to the video-class driver such that the video-class driver can invoke the micro-port driver.

Thus, the entry function is enabled to serve as an entry point at which the video-class driver invokes the video micro-port driver. The details of the function is expressed as

### Function Name: DriverEntry

### Input Parameter: DriverObject

RegistryPath

### Output Parameter: returned registry result.

In this function, a hardware initialization data structure HW_INITIALIZAION_DATA HwInitData is declared which is filled with the addresses of functions related to request processing and some parameters about hardware. Then HwInitData is used as a parameter to invoke the StreamClassRegisterAdapter( ) function of the video-class driver for registry, so as to facilitate the invocation.

Note that the driver entry function invokes the StreamClassRegisterAdapter( ) function of the video-class driver to implement registry by means of the addresses of functions related to request processing and some parameters about hardware filled in HwInitData.

(2) Device Property Setting Function and Device Property Reading Function the former for setting the properties supported by a video-capturing device during initialization, and the latter for, based on the requirement at the time of video data acquisition, reading particular properties from the properties supported by the video-capturing device as the properties for current acquisition of video data by the video-capturing device.

Said properties of the computer camera device include image resolution, image format, image compression format, video coding format and/or video-data-capturing frequency. Other properties can be included in alternative embodiments of the invention without any substantial change in the implementation of the invention.

The details of the device property setting function is expressed as

### Function Name: VideoSetFormat

### Description: the function is designed to set the format of a video stream and executed when the stream is initially unpacked;

### Input Parameter:

### Video image width supported by the device;

### Video image height supported by the device;

### The number of bytes of a video image pixel supported by the device;

### Video size supported by the device, which can be selected from a group of 320×240, 640×480 and 1024×768 with 320×240 being default value;

### The number of bits of a pixel supported by the device, where 1 represents that the pixel has 8 bits, 2 for 16-bit pixel and 3 for 24-bit pixel, with 3 being a default value;

### Output Parameter: returning TRUE if the video format can be set, otherwise returning FALSE;

### With the function VideoSetFormat, the video-capturing device can be configured to have a maximum size of 1024×768, a minimum size of 160×120 and support pixels of 8 bits, 16 bits and 24 bits;

### Further, the details of the device property reading function is expressed as

### Function Name: VideoGetProperty

### Description: the function is designed to process functions requested by video properties;

### Input Parameter: pSrb which is a video request packet pointing to property setting and in which the result is stored and returned;

### Output Parameter Success or Failure.

As mentioned above, the function VideoSetFormat serves to setting device properties, and the corresponding function VideoGetProperty serves to acquire the range of the values of various device properties. The setting function is intended to define a value in the range of the values of various device properties, for example, given that the range of video size supported by the device covers 320×240, 640×480 and 1024×768, 320×240 can be used as the parameter upon invoking the device functions, and this represents the value of such property, i.e., current video size of the device, is 320×240.

### (3) Device Adding and Uninstalling Function for adding and uninstalling the computer camera device to and from the computer and the details of which is expressed as

### Function Name: VCamInit

### Description: the function is designed to add the computer camera device to the computer during initialization;

### Input Parameter: none

### Output: Success or Failure code

### Function Name: VCamFinish

### Description: the function is designed to uninstall the computer camera device from the computer;

### Input Parameter: none

### Output: Success or Failure code

### (4) Video-Data acquiring Function for controlling the camera mobile phone and acquiring video data from the mobile phone based on the defined properties for current acquisition of video data by the video device.

The details of the function is express as

### Function Name: VideoCaptureRoutine

### Description: the function is designed to acquire a frame of image;

### Input Parameter: pStrmEx which is an extended structure pointing to the video stream;

### Output Parameter: none.

The above has been illustrated the specific implementation of step 301 for providing a virtual computer camera driver, and the description of this embodiment will be continued by referring to FIG. 3 again.

Steps 302 and 303: the virtual driver in step 301 is executed to register the camera mobile phone to the operating system, and then the properties supported by the camera mobile phone are set. In this embodiment, the video micro-port driver is registered to the video-class driver by invoking the function DriverEntry during initialization, and thereby step 302 is fulfilled. Besides, step 303 can be carried out by invoking the function VideoSetFormat.

Step 304: the camera mobile phone corresponding to the virtual driver is added to the computer by using the function provided by the virtual driver, and then the mobile phone is selected as the current video-capturing device of the computer by an application; the step of adding the camera mobile phone can be carried out by invoking the above function VcamInit.

Step 305: the application sends the command for acquiring video data to the virtual driver via the operating system and reads from the properties supported by the mobile phone particular properties as the device attributions for acquiring the current video data; specifically, the application can set the device properties for the current video data by invoking the above function VideoSetProperty.

Step 306: after receiving the command for acquiring video data sent by the application, the virtual driver converts the command for acquiring video data into a corresponding control command for the mobile phone according to the read device attributions for acquiring the current video data and sends the converted command to the mobile phone via a wireless communication between the computer and the mobile phone; the setting result obtained after the invocation of the function VideoSetProperty is represented in the control command.

Step 307: the control and operation module of the mobile phone receives the control command from the computer via the wireless communication module, and the mobile phone performs the acquisition of video data according to the control command.

Step 308: the virtual driver utilizes the wireless communication between the computer and the mobile to acquire video data from the mobile phone; in this embodiment, this step can be conducted by invoking the above function VideoCaptureRoutine.

Step 309: the virtual driver invokes a device-reading routine owned by the virtual driver itself and transmits the video data acquired from the mobile phone to the upper-layer application for use. After obtaining the video data from the mobile phone, the virtual driver stores the data in the memory of the computer. In order to store the video data transmitted from the side of the mobile phone, the class driver allocates to each video-capturing device one independent memory block defining a byte data array sized as 1024×768×3+size of (BITMAPINFOHEADER), and thereby each video-capturing device can have its own independent memory cell. The video data from the mobile phone will be copied to the memory area along with bitmap information and bitmap data. The virtual driver transforms the video data in the aspects including format and/or size according to the acquisition format as required by the user and the bitmap format in the memory area, and then provides the video data of appropriate format and/or size to the upper-layer application for use. Thereafter, the upper-layer application can play the video data or store it in hard disk.

The above has described one embodiment of the present invention in which the video data is transmitted from the mobile phone to the computer via wireless communication as it is. In this process, however, the video data can also be compressed in, for example, MJPEG format at first, and then the compressed video data is transmitted to the computer via wireless communication. This can reduce the bandwidth consumption for wireless communication and facilitate practical application of the technology in question. After receiving the compressed video data, the computer decompresses the data and recoveries it to the original video data.

The upper-layer application in the invention can be an application for video chatting or web conferencing, and any other application utilizing video data can also be employed as the application in the invention and won't bring any substantial change to the implementation of the invention.

In the embodiment of the invention, at the end of execution of the application, the mobile phone acting as a computer camera can also be uninstalled from the computer by invoking the function for uninstalling the computer camera device from the virtual driver.

The above discloses only the preferred embodiment of the present invention and has no intention to limit the present invention. Therefore, any modification, substitution and change made within the spirit and principle of the present invention should be contained in the scope of the invention.

What is claimed is:

1. A method for acquiring video data by using a camera mobile phone as a computer camera, comprising:
Step A: virtualizing the camera mobile phone as a video-capturing device in a computer;
Step B: selecting the mobile phone virtualized as the video-capturing device in said step A as current video-capturing device of the computer;
Step C: sending a command for acquiring video data to the mobile phone selected as the current video-capturing device by the computer, and acquiring the video data according to the received command by said mobile phone and transmitting to the computer via a wireless connection; and
Step D: receiving the video data transmitted from the mobile phone by the computer.

2. The method according to claim 1, wherein said step A further comprises:
Step A1: providing a virtual computer camera driver, which includes at least a function for registering a computer camera device, a function for setting and reading the properties of the computer camera device, a function for adding/uninstalling the computer camera device and a function for acquiring video data from the mobile phone; and
Step A2: executing the virtual driver in said step A1, registering the camera mobile phone to the operating system of the computer, and setting the properties supported by the mobile phone.

3. The method according to claim 2, wherein said virtual driver is a video micro-port driver for providing a callback routine to a video-class driver; and the video-class driver encapsulates general features of different types of streaming devices to support the control and manipulation of the video-capturing device by an application.

4. The method according to claim 2, wherein said setting the properties supported by the mobile phone in said step A2 comprises:
invoking the function for setting the properties of the computer camera device and setting image resolution, image format, image compression format, video coding format and/or video-data-capturing frequency support by said mobile phone.

5. The method according to claim 2, wherein said step B further comprises:
invoking said function for adding the computer camera device to add the mobile phone corresponding to the virtual driver to the computer, and then the mobile phone being selected as the current video-capturing device of the computer through an application.

6. The method according to claim 2, wherein said step C further comprises:
Step C1: sending the command for acquiring video data to the virtual driver via the operating system by an application in the computer, and invoking said function for reading the properties of the computer camera device to read from the properties supported by the mobile phone particular properties as the device attributions for acquiring the current video data;
Step C2: converting the command, by the virtual driver, for acquiring video data into a corresponding control command for the mobile phone according to the read device attributions for acquiring the current video data and sending the converted command to the mobile phone via a wireless communication between the computer and the mobile phone, wherein the device attributions for acquiring the current video data is represented in said control command;
Step C3: performing the acquisition of video data according to said received control command by the mobile phone; and
Step C4: using the wireless communication between the computer and the mobile phone, by the virtual driver, to acquire video data from the mobile phone by invoking said function for acquiring video data from the mobile phone and to transmit the acquired video data to the application in the computer.

7. The method according to claim 6, further comprising:
allocating in advance each independent memory block to corresponding video-capturing device, respectively, and
wherein said transmitting the video data to the application by the virtual driver in said step C4 comprises:
the virtual driver transmitting video data stored in said independent memory block up to the application through a device-reading routine owned by the virtual driver itself.

8. The method according to claim 7, wherein, before the virtual driver transmits the video data up to the application, the method further comprises transforming the format of the video data in the aspects including format and/or size.

9. The method according to claim 1, wherein before said transmitting the video data to the computer in said step C, the method further comprises compressing the video data to be transmitted and then transmitting the compressed video data to the computer; and
said step D further comprises restoring the received compressed video data to original video data by the computer.

10. The method according to claim 1, wherein said step D further comprises using said received video data as data source and playing or storing the video data by the application in the computer.

11. The method according to claim 10, wherein said application is an application for video chatting or web conferencing.

12. The method according to claim 2, further comprising:
after said step D, invoking said function for uninstalling the computer camera device to uninstall the mobile phone corresponding to the virtual driver from the computer.
